(19) United States
(12) Patent Application Publication
(10) Pub. No.: US 2024/0289901 A1
(43) Pub. Date: Aug. 29, 2024

(54) MANAGING A CONSTRUCTION PROJECT WITH THE HELP OF AERIAL-CAPTURED IMAGES

(71) Applicant: SITEAWARE SYSTEMS LTD, Tel Aviv (IL)

(72) Inventors: Ori APHEK, Ramat Gan (IL); Maayan SHEKEL, Mishmar Hashiva (IL); Zeev BRAUDE, Ramat Gan (IL)

(21) Appl. No.: 18/586,726

(22) Filed: Feb. 26, 2024

(30) Foreign Application Priority Data
Feb. 26, 2023 (IL) 300927

(51) Int. Cl. G06Q 50/08; G06T 7/70; G06T 7/80; G06V 10/70; G06V 20/10; G06V 20/17

(52) U.S. Cl. CPC G06Q 50/08; G06T 7/70; G06T 7/80; G06V 10/70; G06V 20/17; G06V 20/176; G06T 2207/10032; G06T 2207/20081; G06T 2207/30184; G06T 2207/30244

(57) ABSTRACT

The is provided a technique of managing a construction project. The technique comprises: processing a plurality of overlapping aerial images of an “as-built” construction layout comprising “as-built” construction elements (BCEs) to recognize in each of the captured images one or more BCE instances characterized by respective classes and image-space coordinates thereof; transforming image-space coordinates of the recognized BCE instances into respective 3D reference-space coordinates of respective BCEs; verifying the “as-built” construction layout by comparing, at least, class and 3D reference-space coordinates of the BCEs with, at least, class and 3D reference-space coordinates of the “as-designed” construction elements, wherein results of verifying are informative, at least, of a missing BCE, a mis-placed BCE and/or a false BCE; and using the results of verifying to cause one or more corrective actions and/or for triggering a delay of a critical construction action.

### CROSS-REFERENCES TO RELATED APPLICATIONS

The present application claims benefit from IL patent application No. 300927 filed on Feb. 26, 2023, and incorporated hereby by reference in its entirety.

### TECHNICAL FIELD

The presently disclosed subject matter relates to systems and methods of managing construction projects and, more particularly, to systems and methods of managing construction projects with the help of aerial-captured images.

### BACKGROUND

The construction industry has seen significant changes and improvements since the introduction of aerial images captured from the jobsites. The aerial images can be acquired by various sensors ((collectively referred thereto as “cameras”) mounted on UAVs (unmanned aerial vehicles), construction cranes and/or other suitable movable imaging devices. Among known prominent applications of aerial-captured images in construction are site surveillance, land surveying, asset inspection (e.g. for damages analyses) and documenting and progress monitoring as a part of managing a construction project.

Problems of implementing aerial-captured images for construction industry have been recognized in the conventional art and various techniques have been developed to provide solutions, for example:

US Patent Publication No. US2017/0206648 entitled “System and Method for Structural Inspection and Construction Estimation Using an Unmanned Aerial Vehicle” discloses a technique of operating a UAV via a mobile computing device to capture images of a structure area of interest (AOI). After data acquisition, the mobile computing device then transmits the UAV output data to a server for further processing. At the server, the UAV output data can be used for a three-dimensional reconstruction process. The server then generates a vector model from the images that precisely represents the dimensions of the structure. The server can then generate a report for inspection and construction estimation.

US Patent Publication No. US2017/0249510 entitled “System and Method for Performing Video or Still Image Analysis on Building Structures” discloses a technique for automating the management and processing of roof damage analysis. In some embodiments image data associated with damaged roofs is collected and automatically analysed by a computing device. In some embodiments, the image data is modified automatically to include descriptive metadata and visual indicia marking potential areas of damage. In one embodiment, the systems and methods include a remote computing device receiving visual data associated with one or more roofs. In one embodiment, insurance company specific weightings are determined and applied to received information to determine a type and extent of damage to the associated roof.

US Patent Publication No. US2019/0102624 entitled “Pile Head Analysis System, Pile Head Analysis Method and Storage Medium” discloses a technique comprising: capturing, by a pile head analysis system, a plurality of images of a construction site including a pile using a camera mounted on an unmanned aerial vehicle (UAV), generating a three-dimensional model of the construction site, detecting a pile head from the three-dimensional model, and determining consistency between the detected pile head and preliminarily acquired design information.

US Patent Publication No. US2020/0065971 entitled “Imagery-Based Construction Progress Tracking” discloses a method including one or more of receiving, by an image processing device, one or more images from an image capture device. The one or more images are each associated with metadata that includes a common direction. For each of the one or more images, the method further includes adding one or more pairs of parallel lines, converting each of the one or more pairs of parallel lines into intersection coordinates with 2D drawing elements, and calculating construction progress from the intersection coordinates. The 2D drawing includes a 2D floor plan or a 2D elevation plan, and each pair of parallel lines designates the start or the end of construction during a current period of time.

US Patent Publication No. US2022/0397917 entitled “Systems and Methods for 3D Model Based Drone Flight Planning And Control” discloses a method for controlling a plurality of drones to survey a location, the method comprising, at a computing system: automatically generating preliminary flight plans for a plurality of drones to survey the location based on a 3D model; receiving survey data from the plurality of drones as the plurality of drones are surveying the location based on the preliminary flight plans; updating the 3D model based on the survey data received from the plurality of drones; and automatically updating at least a portion of the flight plans based on the updated 3D model

International Patent Publication No. WO22/149071 entitled “Capturing and Analysis Of Construction Site Images” discloses a technique for capturing and analysis of construction site images, for analysing construction site images for supply chain management, for selecting capturing frequency of construction site images, for identifying future construction errors in prospective construction works from previously captured construction site images, for causing changes to prospective activities based on an analysis of construction site images, and for aligning construction site images to three-dimensional models.

The references cited above teach background information that may be applicable to the presently disclosed subject matter. Therefore, the full contents of these publications are incorporated by reference herein where appropriate for appropriate teachings of additional or alternative details, features and/or technical background.

### GENERAL DESCRIPTION

Typically, complex constructing structures (e.g. concrete decks, steel structures, multi-layered facades, etc.) require a proper installation/assembly of many different construction elements (e.g. beams, pipes, ducts, studs, walls, etc.). Many of these tasks require dimensionally precise installation according to the layout prescribed in the construction plans. Unfortunately, the construction process is subject to errors, which can cause significant amounts of re-work and schedule delay.

The inventors have recognized and appreciated that the aerial-based images can be beneficial for enabling automated verification of conformance between “as-built” and “as-designed” layouts prior to providing a construction action, especially when the construction action (e.g. concrete pouring, coverage by another façade layer, etc.) at least partly prevents a later correction of an improper “as-built” layout. Such verification can be provided by comparing “as-built” and “as-designed” construction elements and parameters thereof.

In accordance with certain aspects of the currently presented subject matter, there is provided a method of managing a construction project in accordance with “as-designed” construction layout comprising one or more “as-designed” construction elements. The method comprises: using one or more cameras to capture a plurality of overlapping aerial images of an “as-built” construction layout comprising “as-built” construction elements (BCEs); processing, by a computer, data informative of the plurality of overlapping captured images to recognize in each of the captured images one or more BCE instances of BCEs and to define respective classes and image-space coordinates thereof, thereby giving rise to recognized BCE instances. The method further comprises transforming image-space coordinates of the recognized BCE instances into respective three-dimensional (3D) reference-space coordinates of respective BCEs, wherein, for a given BCE of a given class, transforming into 3D reference-space coordinates comprises: identifying, among the recognized BCE instances of BCEs of the given class, BCE instances representing the given BCE, thereby given rise to identical BCE instances and obtaining 3D reference-space coordinates of the given BCE as corresponding to the best approximated intersect point of projecting image-space coordinates of the identified identical BCE instances. The computer further verifies the “as-built” construction layout by comparing, at least, class and 3D reference-space coordinates of the BCEs with, at least, class and 3D reference-space coordinates of the one or more “as-designed” construction elements, wherein results of verifying are informative, at least, of a missing BCE, a mis-placed BCE and/or a false BCE; and enables using the results of verifying to cause one or more corrective actions and/or for triggering a delay of a critical construction action.

The verification results can be used for generating a report rendering the verification results and thereby enabling one or more corrective actions and/or for generating an alert triggering a delay of a critical construction action.

In accordance with further aspects of the currently presented subject matter, each aerial-captured image comprises data informative of its capture coordinates. The data informative of the capture coordinates of an image can be metadata associated with the given image and informative of GPS-based location of a respective sensor at the moment of capturing the image or is data informative of at least one target object presented in the image and usable for calculating the capture coordinates.

In accordance with further aspects of the currently presented subject matter, the BCEs instances can be recognized by applying to the obtained images a machine learning model trained to detect the BCE instances in the respective images and to define, for each detected BCE instance, its class and image-space coordinates of an anchor point thereof. Optionally, the machine learning model can comprise several sub-models, each trained to detect its certain class of the BCE instances.

In accordance with further aspects of the currently presented subject matter, the method can comprise calibrating, at least, extrinsic parameters of respective capturing cameras, wherein the calibrating, at least, extrinsic parameters of the cameras is used to generate a transformation structure usable for transforming image-space coordinates of the recognized BCE instances into respective reference-space coordinates. The camera calibrating can comprise detecting the camera poses corresponding to the captured images with the help of triangulating a plurality of interest points within the images.

In accordance with other aspects of the currently presented subject matter, there are provided one or more computing devices comprising processors and memory, the one or more computing devices configured, via computer-executable instructions, to perform operations for operating, in a cloud computing environment, a system capable of managing a construction project in accordance with “as-designed” layout comprising one or more “as-designed” construction elements, the system further configured to operate in accordance with the method above.

In accordance with other aspects of the currently presented subject matter, there is provided a non-transitory computer-readable medium comprising instructions that, when executed by a computing system comprising a memory storing a plurality of program components executable by the computing system, cause the computing system to enable managing a construction project in accordance with “as-designed” layout comprising one or more “as-designed” construction elements in accordance with the method above.

In accordance with other aspects of the currently presented subject matter, there is provided a computer-based system configured to manage a construction project in accordance with “as-designed” layout comprising one or more “as-designed” construction elements, the system further configured to operate in accordance with the method above.

Among advantages of certain embodiments of the presently disclosed subject matter is capability of fast and accurate verification of conformity between “as-built” and “as-designed” layouts comprising multiple elements sharing the common characteristics and/or attributes. The verification allows to reveal, for example, the position errors, missing and/or added scope and to provide the respective corrections (when required) prior to providing construction actions.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized diagram of an exemplary construction environment including a Construction Project Management System (CPMS) configured in accordance with certain embodiments of the presently disclosed subject matter;

FIG. 2 illustrates a generalized flow chart of managing a construction project with the help of aerial-captured images in accordance with certain embodiments of the presently disclosed subject matter;

FIG. 3 illustrates a generalized flow chart of generating a “as-built” data structure informative of the construction layout “as built”;

FIG. 4 illustrates a generalized flow chart of obtaining 3D reference-space coordinates of “as-built” construction elements in accordance with certain embodiments of the presently disclosed subject matter; and

FIG. 5 illustrates a schematic example of using identical BCE instances recognized in different overlapping images in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “applying”, “comparing”, “generating”, “matching”, “detecting”, “recognizing”, “registering” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, Construction Project Management System (CPMS) and processing and memory (PMC) circuitry therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

For purpose of illustration only, the following description is provided in relation to concrete pouring of a floor (deck). Those skilled in the art will readily appreciate that the teachings of the presently disclosed subject matter are, likewise, applicable to other construction actions requiring inspection of a layout “as-built” prior to the respective action.

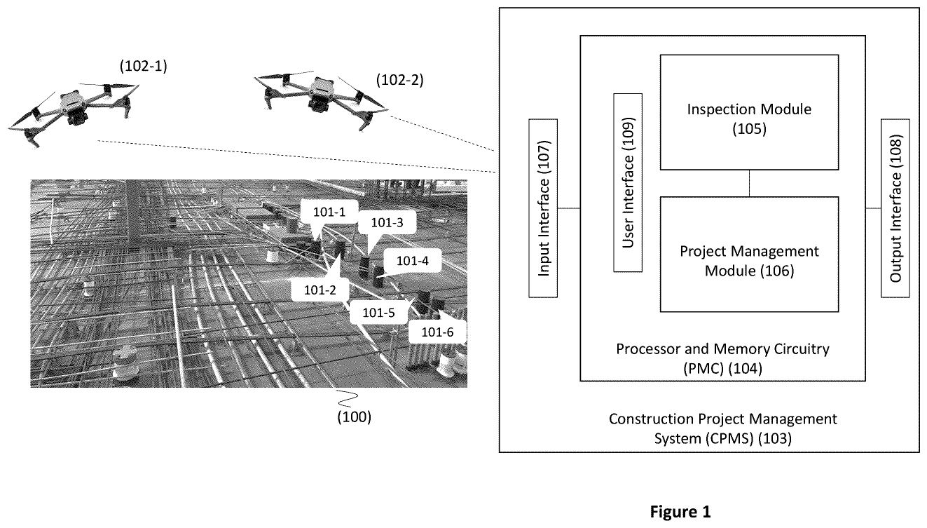

Bearing this in mind, attention is drawn to FIG. 1 illustrating a generalized diagram of an exemplary construction environment including a Construction Project Management System (CPMS) configured in accordance with certain embodiments of the presently disclosed subject matter.

CPMS 103 is configured to obtain data informative of aerial-captured images of a construction layout of interest 100 “as-built”.

The aerial images can be captured by cameras mounted on UAVs (unmanned aerial vehicles) illustrated as 102-1 and 102-2, construction cranes and/or other suitable movable imaging devices. By way of non-limiting example, the aerial-captured images can be captured with the help of RGB, monochrome, multispectral, infrared, thermal, and/or other sensors (collectively referred thereto as “cameras”), wherein the layout and/or parts thereof are photographed multiple times from different angles and camera positions.

Each image can be tagged with its capture coordinates (geo-tagged). Alternatively or additionally, the capture coordinates can be obtained with the help of Ground Control Points that can be laid out and measured.

The exemplified “as-built” construction layout 100 is a part of a building floor (deck) prepared for concrete pouring.

It is noted that the term “construction layout” used herein should be expansively construed to cover any 2D or 3D arrangement (as-designed or as-built) of a plurality of construction elements within an area of interest. The construction layout can include all construction elements within the area of interest or only construction elements pre-defined by type (e.g. plumbing elements, slab edge layout, embedded devices, electrical elements, mechanical elements, steel reinforcement, etc.), location, orientation, relative location (e.g. in a predefined proximity of a certain element), class or otherwise. The construction layout may have horizontal, vertical or any other orientation defined in the construction project.

Layout 100 can comprise different types of construction elements as, for example, different sleeves, bare steel rebars, tension cables, electrical conduits, blockouts, vertical wooden forms and more. These construction elements need to be properly placed according to “as-designed” construction layout prior to concrete pour.

Construction elements of the same type that share common predefined characteristic(s) and/or attribute(s) (e.g. size, shape, orientation, colour, etc.) are referred to hereinafter as belonging to the same class. By way of non-limiting example, plumbing elements 101-1-101-6 are of the same type, the size of elements 101-1-101-4 is equal but differs from the size of elements 101-5-101-6. Accordingly, when the class is defined by a size of elements of the same type, plumbing elements 101-1-101-4 belong to the same class, and plumbing elements 101-5 and 101-6 belong to another class. Characteristics/attributes of a class can be specified in accordance with design data.

It is noted that a construction layout can comprise multiple construction elements belonging to the same class and having different coordinates.

CPMS 103 comprises a processing and memory circuitry (PMC) 104. PMC 104 comprises a processor and a memory (not shown separately within the PMC) and is operatively connected to an input interface 107 and an output interface 108. CPMS 103 is configured to receive the captured images and/or derivatives thereof via input interface 107. The respective data can be received directly from the movable imaging device(s) and/or from one or more external systems (not shown) operatively coupled to the movable imaging devices and receiving data therefrom.

PMC 104 is configured to execute several program components in accordance with computer-readable instructions implemented on a non-transitory computer-readable storage medium. Such executable program components are referred to hereinafter as functional modules comprised in the PMC. The functional modules can be implemented in any appropriate combination of software with firmware and/or hardware.

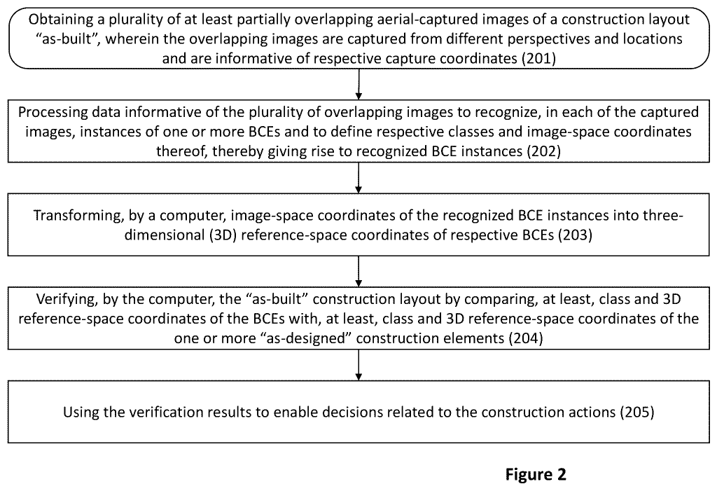

PMC 104 can comprise an inspection functional module 105 operatively connected to a project management functional module 106. As will be further detailed with reference to FIGS. 2-5, inspection module 105 is configured to process the acquired data informative of aerial-captured images to recognize construction elements in the construction layout “as-built” (e.g. in layout 101) and parameters thereof.

By way of non-limiting example, the parameters of a construction element can include size, shape, colour, (X, Y and, optionally Z) coordinates of its anchor point(s) (i.e. one or more points characterizing a location of the element), and/or other parameters specified by design data.

Inspection module 105 is further configured to obtain data informative of construction elements comprised in a corresponding construction layout “as-designed” and parameters thereof. Such construction elements are referred to hereinafter as construction elements “as-designed”. Data informative of the construction elements “as-designed” can be derived (by inspection module 105 and/or by an external system) from design data representative of a desired construction layout. Design data and/or data derived thereof (e.g. construction elements “as-designed” and parameters thereof) can be stored in an accessible to PMC 104 data repository (not shown) located in CPMS 103 or in an external system operatively connected to CPMS 103.

The term “design data” used in the specification should be expansively construed to cover any data informative of a desired physical design of a respective construction layout and of constituting construction elements. Design data can be provided in different formats as, by way of non-limiting examples, DWG files, DXF files, BIM files, etc.

Inspection module 105 is further configured to compare the recognized construction elements (and parameters thereof) “as-built” with construction elements “as-designed” to find discrepancies therebetween (e.g. position errors, missing and/or added scope, etc.), thereby obtaining verification data, and to forward the verification data to project management module 106.

Project management module 106 is configured to use the received verification data for enabling decision(s) related to construction action. By way of non-limiting example, project management module 106 can be configured to use the verification data to generate an inspection report and/or to generate an alert when the revealed discrepancies exceed a predefined threshold. For example, such threshold can be provided in the design data, or derived from the tolerance indicated therein. Project management module 106 can send the generated report and/or alert to a rendering system (not shown) via output interface 108. Optionally, the rendering system can be a part of CPMS 103.

A manager of the construction project (a person or an application) can use the generated report/alert to take a decision related to the construction project (e.g. approve or delay concrete pouring, limit the pouring by certain area where the revealed discrepancies meet predefined criteria, correct location of mis-placed elements, install missing elements, etc.).

Optionally, PMC 104 can comprise a user interface 109 operatively connected to inspection module 105 and/or project management module 106. User interface 109 can enable a user to define construction elements of interest (including classes thereof), discrepancy thresholds, data to be reported/alerted, etc.

Operating CPMS 103 is further detailed with reference to FIGS. 2-5.

It is noted that the teachings of the presently disclosed subject matter are not bound by the CPMS system described with reference to FIG. 1. Equivalent and/or modified functionality can be consolidated or divided in another manner and can be implemented in any appropriate combination of software with firmware and/or hardware and executed on one or more suitable devices. At least part of the functionality of the CPMS can be implemented in a cloud and/or distributed and/or virtualized computing arrangement.

Referring to FIG. 2, there is illustrated a generalized flow chart of managing a construction project in accordance with certain embodiments of the presently disclosed subject matter.

CPMS 103 obtains (201) data informative of a plurality of at least partially overlapping aerial-captured images of a construction layout “as-built”. The overlapping images are captured from different perspectives and locations and are informative of respective capture coordinates.

The same “as-built” construction element (referred to hereinafter as BCE) can be represented in several captured images, a representation of a BCE in a captured image is referred to hereinafter as a “BCE instance”.

Upon obtaining (201) data informative of the plurality of overlapping aerial-captured images of a construction layout “as-built”, CPMS 103 processes the obtained data to recognize (202), in each of the captured images, instances of one or more BCEs and to define respective classes and image-space coordinates thereof. A BCE instance with defined class and image-space coordinates (with regard to a respective image) is referred to hereinafter as a recognized BCE instance.

BCE instances of the same class can represent BCEs with different locations (e.g. BCEs 101-1-101-4). BCE instances in overlapping different images representing the same BCE (at the same location) are referred to hereinafter as “identical BCE instances”.

Each aerial-captured image comprises data informative of its capture coordinates. By way of non-limiting example, a given image can be associated with metadata informative of GPS-based location of the sensor (e.g. camera) at the moment of capturing the image.

Alternatively or additionally, a captured image can include at least one target object (referred to hereinafter also as “target”) recognizable within its environment. The subsequent processing can use the location of one or more targets presented in the image as data informative of the capture coordinates of the respective image.

By way of non-limiting example, at least one of the targets can be a ground control point (GCP) object with predefined coordinates and shape, pre-located in the “as-built” layout and presented in the image. Alternatively or additionally, subsequent processing of the images can post-define at least one of the “as-built” construction elements (or part thereof) as a target object and use such target object for calculating the capture coordinates.

By way of non-limiting example, recognizing the BCE instances can be provided with the help of geometric computer vision algorithms and/or other suitable photogrammetric algorithms.

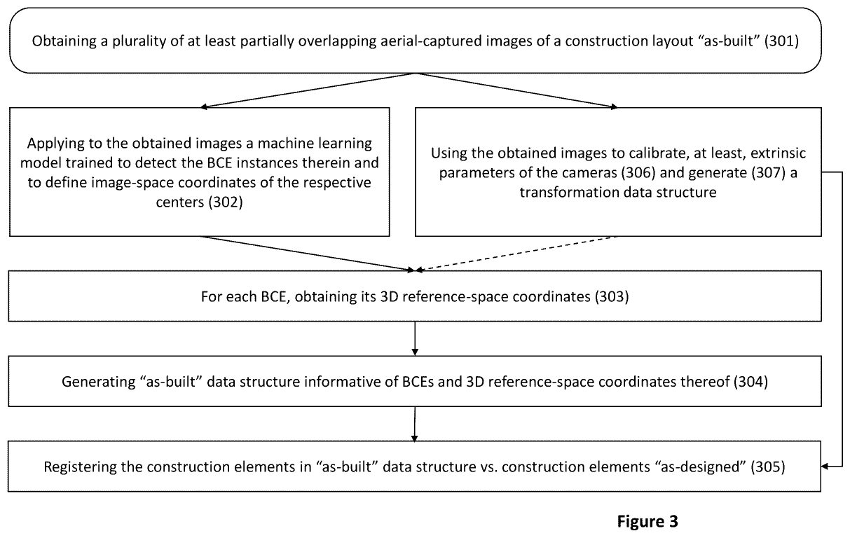

As will be further detailed with reference to FIGS. 3-5, in accordance with certain embodiments, the BCE instances can be recognized also with the help of Deep Neural Networks.

CPMS 103 further transforms (203) image-space coordinates of the recognized BCE instances into three-dimensional (3D) reference-space coordinates of respective BCEs.

CPMS 103 verifies (204) the “as-built” construction layout by comparing, at least, class and 3D reference-space coordinates of the BCEs with, at least, class and 3D reference-space coordinates of the one or more “as-designed” construction elements.

By way of non-limiting example, “as-designed” construction elements of the respective layout and the respective parameters (e.g. coordinates) can be derived from design data offline and be stored in an appropriate database. In certain embodiments, “as-designed” construction elements can be derived from the design data with the help of machine learning model trained to recognize and extract patterns.

The verification results (e.g. data informative of wrong, missing or mispositioned construction elements “as-built” or of other discrepancies) are used (205) to enable decisions related to the construction actions.

By way of non-limiting example, CPMS 103 can generate a report rendering the verification results and thereby enabling corrective actions (e.g. correction of location of rendered mis-placed elements, installation of rendered missing elements, etc.). Alternatively or additionally, CPMS 103 can generate an alert triggering a delay of a critical action (e.g. concrete pouring in a certain area or the entire deck). In certain embodiments CPMS 103 can generate such alert only when the discrepancies exceed preconfigured thresholds.

It is noted that verification of “as-built” layout and/or rendering the verification results (and/or the respective alerting) can be provided selectively and/or separately for different classes of the construction elements, location and/or relative location thereof, severity thereof and/or other criteria configurable by the user.

FIG. 3 illustrates a generalized flow chart of generating an “as-built” data structure informative of the construction layout “as built” and including data of recognized BCEs and parameters thereof in accordance with certain embodiments of the presently disclosed subject matter.

For purpose of illustration only, the following description is provided with respect to construction elements characterized by an external rectangular boundary which location is characterized by an anchor point selected as being in the centre of the rectangle. Those versed in the art will readily appreciate that the teachings of the presently disclosed subject matter are, likewise, applicable to other external boundaries (e.g. circles, lines, etc.) and/or other selection of anchor points (e.g. the corners of a rectangular, end points for a linear object, etc.).

For purpose of illustration only, the following description, unless specifically stated otherwise, is provided with respect to the images comprising GPS-based data informative of the respective capture coordinates (geotagged images). Those versed in the art will readily appreciate that the teachings of the presently disclosed subject matter are, likewise, applicable to other data informative of the respective capture coordinates (e.g. data informative of the target objects as explained above).

It is noted that in some embodiments, the geotagging of the images provides the coordinate system to the camera extrinsic parameters which may be precisely in the reference-space coordinates or may require an additional pre-defined transformation to migrate from the geotagging coordinate system to the reference-space coordinates. In other cases, the coordinate system can be obtained with the help of the target objects. Transformation to the reference-space coordinates can be provided with the help of an alignment process. For example, a few elements may be identified (automatically or with a user involvement) both in the captured images and in the design. The transformation between the two coordinate systems can be calculated by aligning these elements to each other.

In accordance with certain embodiments of the presently disclosed subject matter, recognizing construction elements “as-built” (BCEs) is based on obtaining (301) a plurality of overlapping aerial-captured images of a construction layout “as-built”, the images being informative of capture coordinates (e.g. geotagged). In certain implementations the overlapping in each direction can reach 60-80% or even 100%. The geotagged overlapping images can be captured from different perspectives, with absence of knowledge of respective camera poses, or with knowledge of respective camera poses in low accuracy that may only serve as a first guess. The term “camera pose” is referred to the position and orientation of a camera with respect to a reference coordinate system (referred to hereinafter also as layout coordinate system).

CPMS 103 applies to the obtained images a machine learning model trained to detect (302) the BCE instances of predefined one or more classes therein and to define image-space coordinates of the respective centres (or other anchor points), thereby yielding recognized BCE instances. By way of non-limiting example, the machine learning model can be configured as a Convolutional Neural Network (e.g. CenterNet Network), based on algorithms from OpenCV (Open-Source Computer Vision Library) (e.g. cv2.HoughCircles function and alike), etc.

As stated above, a BCE instance detected in an image and characterized by a class and image-space coordinates is referred to hereinafter as a “recognized” BCE instance.

Optionally, the machine learning model (MLM) can comprise several sub-models, each trained to recognize the BCE instances belonging to one or more classes predetermined for the respective sub-model. By way of non-limiting example, one sub-model can be trained to classify plumbing elements of different sizes and another sub-model can be trained to classify electrical conduits of different colours, etc. Training can be provided with the help of images (real and/or synthetic) of the layout obtained from different camera poses (i.e. locations and perspectives) and comprising labelled elements.

CPMS 103 obtains (303) 3D reference-space coordinates for each BCE corresponding to the recognized BCE instances and generates (304) “as-built” data structure (e.g. a list or a database of BCEs) informative of classes of “as-built” construction elements and 3D reference-space coordinates thereof.

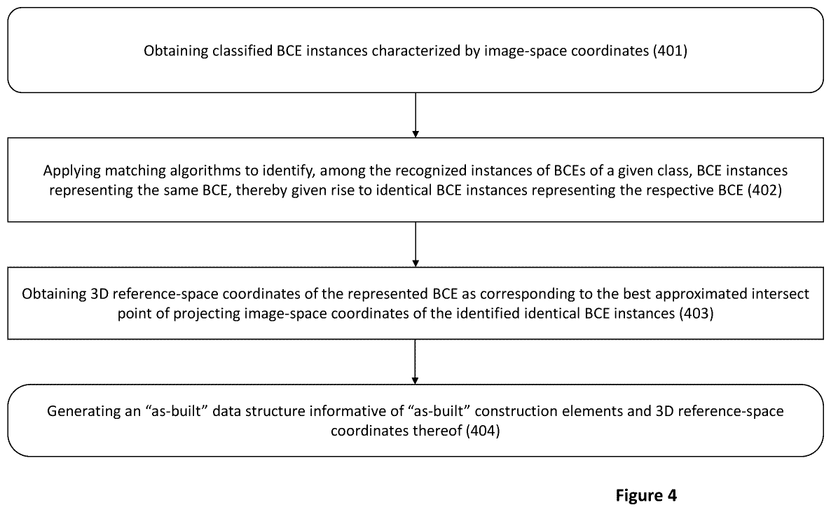

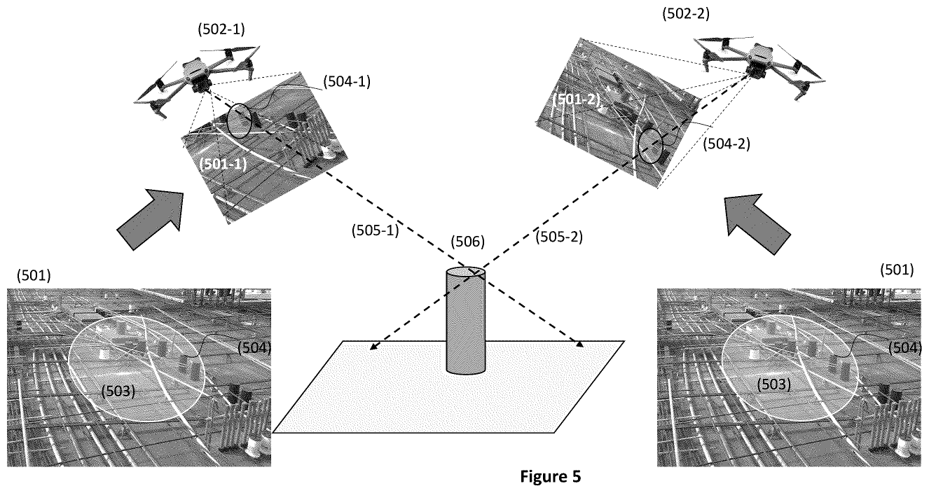

Obtaining 3D reference-space coordinates of BCEs is further detailed with reference to FIGS. 4-5.

CPMS 103 registers (305) the construction elements in “as-built” data structure vs. construction elements “as-designed”, thereby yielding pairs of “as-built”-“as-designed” construction elements having the same 3D locations.

Optionally, CPMS 103 can use the obtained images to calibrate (306) parameters of the cameras and to generate (307) a transformation structure. The transformation structure associates, for each image, image-space coordinates (i.e. coordinates relative to the respective images) of the pixels corresponding to the BCE instances recognized therein with reference-space coordinates (e.g. layout-space coordinates), i.e. coordinates in a reference system common to all “as-built” construction elements and to “as-designed” construction elements.

Camera's parameters include extrinsic and intrinsic parameters.

Intrinsic calibration determines distortions in the images due to the optical properties of the camera lens (e.g. focal point, principal point, distortion coefficients, etc.). The intrinsic calibration can be performed ahead of the image capture (e.g. in a lab) or can be provided jointly with the extrinsic parameters using the captured images.

Extrinsic camera calibration determines the camera poses (six degrees of freedom of the location and orientation of capturing camera) corresponding to the captured images. Camera poses can be determined using triangulation techniques of a plurality of interest points. Interest points are two-dimensional (2D) objects in the images which are recognizable, stable and repeatable from different lighting conditions and view-points in different overlapping images from the image set. Such objects appear in more than one image and can serve as a “tie point” between the respective overlapping images.

By way of non-limiting example, the tie points can be detected with the help of SIFT (Scale-Invariant Feature Transform) algorithms (e.g. see Lowe, David G. (2004). “Distinctive Image Features from Scale-Invariant Keypoints”. International Journal of Computer Vision. 60 (2): 91-110).

Extrinsic camera calibration can be provided with the help of Structure From Motion (SFM) algorithms (see, for example, S. Ullman (1979). “The interpretation of structure from motion” (PDF). Proceedings of the Royal Society of London. 203 (1153): 405-426); Schönberger et. al, “Structure-from-Motion Revisited”, 2016 IEEE Conference on Computer Vision and Pattern Recognition (CVPR)).

It is noted that a portion or all extrinsic parameters (e.g. GPS location of the images, camera angels measured by Inertial Navigation Unit, etc.) may be known before using SFM. Nevertheless, this prior data is typically partial (e.g. GPS location without angles) or less accurate than the result of the SFM, and it does not provide consistency with the extrinsic parameters of the other image capture locations.

In certain embodiments, when the “as-built” construction layout is provided with a plurality of ground control points (GCPs) with known locations, shapes and sizes, such GCPs can be used in the aerial-captured images as interest points for triangulation and camera calibration.

Alternatively or additionally, CPMS 103 can apply to the obtained images a second machine learning model (e.g. CNN) trained to detect interest points over a plurality of overlapping images, and to use the detected interest points for detecting, for each image, the respective camera pose.

The generated transformation data structure can be applied to reference-space coordinates of BCE elements at steps 303 or 305 to improve the accuracy of generating the pairs of “as-built”-“as-designed” construction elements having the same 3D locations.

Assuming the construction elements were built exactly according to the design, the “as built” layout should precisely match the “as designed” layout and they could be matched into the pairs of “as-built”-“as-designed” construction elements with the same 3D location. However, in reality, some elements may be missing, may be added, may be placed in the wrong location, or a wrong element may be used (which may result in a wrong class). The combination of such issues may cause ambiguity in the pairing and requires rules and optimization. A non-limiting example for a registration algorithm is an algorithm that minimizes the sum of the distances between pair members over same-class pairing possibilities, while limiting the distance and therefore enabling an element to be left unmatched, enabling identification of missing and added elements.

As detailed above, CPMS 103 further verifies the “as-built” layout by analysing the generated “as-built” and “as-designed” pairs of construction elements and parameters thereof. Missing pair of an “as-built” or “as-designed” construction element is indicative, respectively, of added and/or missing scope. Discrepancies of coordinates in a pair of “as-built”-“as-designed” construction element are indicative of position errors of “as-built” construction elements. Likewise, discrepancies in other parameters (e.g. size, colour, etc.) can be indicative of incorrectly placed “as-built” construction elements.

As illustrated in FIG. 4, upon obtaining (401) in the multiple overlapping images classified BCE instances and image-space coordinates thereof (i.e. recognized BCE instances), CPMS 103 applies one or more matching algorithms to identify (402), among the recognized BCE instances of the same class, identical BCE instances, i.e. BCE instances corresponding to the same BCE element.

For each BCE, CPMS 103 further obtains (403) 3D coordinates corresponding to the best approximated intersect point of projecting anchor points of identical BCE instances from different overlapping images.

By way of non-limiting example, a 3D-based matching algorithm can search for all images comprising identical BCE instances and validate the respective BCE when the projection rays intersecting (with predefined tolerance) at z-coordinate of the element's centre (or other anchor point) match a certain criterion (e.g. when a number of such intersecting rays exceeds a predefined threshold).

Z-coordinate of the element centre (or of another anchor point) can be also used for further eliminating false positives estimation by comparing a height above bottom form with expected height of elements (e.g. height from the bottom deck of forms, sleeves, embeds etc.) If they are not at the height that they are supposed to be, the detected BCEs are considered as false positive.

It is noted that CPMS 103 can further use the redundancy of recognizing the identical BCE instances in more than two images in order to eliminate outliers, use majority vote or other suitable algorithms to improve accuracy and become immune (to a certain level) to MLM detection errors.

Upon recognizing the “as-built” construction elements and the location thereof, CPMS 103 can define, when required, the other parameters of the elements (e.g. size, shape, colour, etc.). Thus, CPMS 103 generates (404) an “as-built” data structure informative of class(es) of “as-built” construction elements and 3D reference-space coordinates (and, optionally, of other parameters) thereof.

FIG. 5 illustrates a schematic example of using identical BCE instances recognized in different overlapping images. UAVs 502-1 and 502-2 capture, with different camera poses, a plurality of overlapping images (e.g. 501-1 and 501-2) from “as-built” layout 501. By way of non-limiting example, the elements of interest are plumbing construction elements in area 503.

As detailed above, as-built” layout 501 comprises multiple construction elements of different types and different classes of the same type. For example, the illustrated area 503 comprises 6 plumping elements of the same class. Thus, it is necessary not only to detect the representations (BCE instances) of such plumbing elements in the overlapping images, but also to identify the identical BCE instances representing the same plumbing element.

Accordingly, after CPMS 103 recognizes BCE instances of one or more plumbing elements in the captured images, it applies matching algorithms to identify in different images the identical BCE instances representing the same plumbing element in “as-built” layout 501. For example, BCE instance 504-1 in image 501-1 and BCE instance 504-2 in image 501-2 are identical as representing the same “as-built” plumbing element 504.

Accordingly, for each given recognized plumbing element, CPMS 103 finds a plurality of overlapping images comprising BCE instances representing the given element and obtains 3D reference-space location of the given element by defining the intersect point of projecting the centres of such identical BCE instances in the plurality of the found overlapping images.

By way of non-limiting example, CPMS 103 can compute a ray from a first BCE instance representing a given plumbing element in one of the images to “as-built” layout 501, thereby providing an initial estimation of the element's location in the layout. Then CPMS 103 can provide a re-projection, i.e. compute an estimated projected location (if any) of the given plumbing element in each captured image using a ray from the initially estimated location to the respective image plain. In each image, the closest recognized BCE instance of plumbing element inside a search radius centred in the estimated projected location is considered as identical to the first BCE instance of the given plumbing element.

Thereby, CPMS 103 finds in the overlapping images the plurality of identical BCE instances and the image-space coordinates thereof.

As illustrated by way of non-limiting example in FIG. 5, images 501-1 and 501-2 comprise identical BCE instances 504-1 and 504-2 representing “as-built” plumbing element 504.

CPMS 103 further computes rays (505-1 and 505-2) from the centres of recognized identical BCE instances to “as-built” layout 501 and finds the best estimation of the BCE reference-space location by minimizing the distance between the rays.

Thereby, CPMS 103 defines 3D reference-space coordinates of respective “as-built” construction element.

It is noted that the teachings of the presently disclosed subject matter are not bound by the method described with reference to FIGS. 3-5. “As-built” construction elements, BCE instances and parameters thereof can be recognized and registered in other suitable ways (e.g. based on orthophoto approach), some of them known in the state of the art.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of managing a construction project in accordance with “as-designed” construction layout comprising one or more “as-designed” construction elements, the method comprising:
using one or more cameras to capture a plurality of overlapping aerial images of an “as-built” construction layout comprising “as-built” construction elements (BCEs);
processing, by a computer, data informative of the plurality of overlapping captured images to:
recognize in each of the captured images one or more BCE instances and define respective classes and image-space coordinates thereof, thereby giving rise to recognized BCE instances;
transforming image-space coordinates of the recognized BCE instances into respective three-dimensional (3D) reference-space coordinates of respective BCEs, wherein, for a given BCE of a given class, transforming into 3D reference-space coordinates comprises:
identifying, among the recognized BCE instances of the given class, BCE instances representing the given BCE, thereby given rise to identical BCE instances; and
obtaining 3D reference-space coordinates of the given BCE as corresponding to the best approximated intersect point of projecting image-space coordinates of the identified identical BCE instances;
verifying, by the computer, the “as-built” construction layout by comparing, at least, class and 3D reference-space coordinates of the BCEs with, at least, class and 3D reference-space coordinates of the one or more “as-designed” construction elements, wherein results of verifying are informative, at least, of a missing BCE, a mis-placed BCE and/or a false BCE; and
using the results of verifying to cause one or more corrective actions and/or for triggering a delay of a critical construction action.

2. The method of claim 1, wherein each aerial-captured image comprises data informative of its capture coordinates.

3. The method of claim 1, wherein the BCEs instances are recognized by applying to the obtained images a machine learning model trained to detect the BCE instances in the respective images and to define, for each detected BCE instance, its class and image-space coordinates of an anchor point thereof.

4. The method of claim 3, wherein the machine learning model comprises several sub-models, each trained to detect its certain class of the BCE instances.

5. The method of claim 1, wherein identifying identical BCE instances is provided by applying matching algorithms.

6. The method of claim 1, further comprising calibrating, at least, extrinsic parameters of respective capturing cameras, wherein the calibrating, at least, extrinsic parameters of the cameras is used to generate a transformation structure usable for transforming image-space coordinates of the recognized BCE instances into respective reference-space coordinates.

7. The method of claim 6, wherein the camera calibrating comprises detecting the camera poses corresponding to the captured images with the help of triangulating a plurality of interest points within the images.

8. The method of claim 7, wherein the interest points are defined by applying to the obtained images a second machine learning model trained to detect interest points over a plurality of overlapping images.

9. One or more computing devices comprising processors and memory circuitry, the one or more computing devices configured, via computer-executable instructions, to perform operations for operating, in a cloud computing environment, a system capable of managing a construction project in accordance with “as-designed” construction layout comprising one or more “as-designed” construction elements, the system further configured to:
process data informative of the plurality of overlapping aerial images of an “as-built” construction layout comprising “as-built” construction elements (BCEs) captured images to:
recognize in each of the captured images one or more BCE instances and define respective classes and image-space coordinates thereof, thereby giving rise to recognized BCE instances;
transform image-space coordinates of the recognized BCE instances into respective three-dimensional (3D) reference-space coordinates of respective BCEs, wherein, for a given BCE of a given class, transforming into 3D reference-space coordinates comprises:
identifying, among the recognized BCE instances of the given class, BCE instances representing the given BCE, thereby given rise to identical BCE instances; and
obtaining 3D reference-space coordinates of the given BCE as corresponding to the best approximated intersect point of projecting image-space coordinates of the identified identical BCE instances;
verify the “as-built” construction layout by comparing, at least, class and 3D reference-space coordinates of the BCEs with, at least, class and 3D reference-space coordinates of the one or more “as-designed” construction elements, wherein results of verifying are informative, at least, of a missing BCE, a mis-placed BCE and/or a false BCE; and
use the results of verifying to cause one or more corrective actions and/or for triggering a delay of a critical construction action.

10. The one or more computing devices of claim 9, wherein the BCE instances are recognized by applying to the obtained images a machine learning model trained to detect the BCE instances in the respective images and to define, for each detected BCE instance, its class and image-space coordinates of an anchor point thereof.

11. The one or more computing devices of claim 10, wherein the machine learning model comprises several sub-models, each trained to detect its certain class of the BCE instances.

12. The one or more computing devices of claim 9, wherein identifying identical BCE instances is provided by applying matching algorithms.

13. The one or more computing devices of claim 9, wherein the system is further configured to calibrate, at least, extrinsic parameters of respective capturing cameras, wherein the calibrating, at least, extrinsic parameters of the cameras is used to generate a transformation structure usable for transforming image-space coordinates of the recognized BCE instances into respective reference-space coordinates.

14. The one or more computing devices of claim 13, wherein the camera calibration comprises detecting the camera poses corresponding to the captured images with the help of triangulating a plurality of interest points within the images.

15. The one or more computing devices of claim 14, wherein the interest points are defined by applying to the obtained images a second machine learning model trained to detect interest points over a plurality of overlapping images.

16. A computer-based system configured to manage a construction project in accordance with “as-designed” construction layout comprising one or more “as-designed” construction elements, the system comprising a processing and memory circuitry (PMC) configured to:
process data informative of the plurality of overlapping aerial images of an “as-built” construction layout comprising “as-built” construction elements (BCEs) captured images to:
recognize in each of the captured images one or more BCE instances and define respective classes and image-space coordinates thereof, thereby giving rise to recognized BCE instances;
transform image-space coordinates of the recognized BCE instances into respective three-dimensional (3D) reference-space coordinates of respective BCEs, wherein, for a given BCE of a given class, transforming into 3D reference-space coordinates comprises:
identifying, among the recognized BCE instances of the given class, BCE instances representing the given BCE, thereby given rise to identical BCE instances; and
obtaining 3D reference-space coordinates of the given BCE as corresponding to the best approximated intersect point of projecting image-space coordinates of the identified identical BCE instances;
verify the “as-built” construction layout by comparing, at least, class and 3D reference-space coordinates of the BCEs with, at least, class and 3D reference-space coordinates of the one or more “as-designed” construction elements, wherein results of verifying are informative, at least, of a missing BCE, a mis-placed BCE and/or a false BCE; and
use the results of verifying to cause one or more corrective actions and/or for triggering a delay of a critical construction action.

17. The system of claim 16, wherein the BCE instances are recognized by applying to the obtained images a machine learning model trained to detect the BCE instances in the respective images and to define, for each detected BCE instance, its class and image-space coordinates of an anchor point thereof.

18. The system of claim 16, wherein the machine learning model comprises several sub-models, each trained to detect its certain class of the BCE instances.

19. The system of claim 16, wherein identifying identical BCE instances is provided by applying matching algorithms.

20. The system of claim 16, wherein the PMC is further configured to calibrate, at least, extrinsic parameters of respective capturing cameras, wherein the calibrating, at least, extrinsic parameters of the cameras is used to generate a transformation structure usable for transforming image-space coordinates of the recognized BCE instances into respective reference-space coordinates.
